(19) United States
(12) Patent Application Publication
(10) Pub. No.: US 2011/0318622 A1
(43) Pub. Date: Dec. 29, 2011

(54) BATTERY HOLDER FOR PORTABLE ELECTRONIC DEVICE

(75) Inventor: MING-CHUN HSIUNG, Shindian (TW)

(73) Assignee: FIH (HONG KONG) LIMITED, Kowloon (HK)

(21) Appl. No.: 12/900,690

(22) Filed: Oct. 8, 2010

(30) Foreign Application Priority Data
Jun. 29, 2010 (CN) 201010211768.5

(51) Int. Cl. H01M 2/10

(52) U.S. Cl. 429/100

(57) ABSTRACT

A battery holder includes a main body, a housing and a latching member. The main body defines a chamber for receiving a battery. A locking portion and a latching portion are positioned at one end of the chamber. An entrance is formed between the locking portion and the latching portion. The entrance allows the battery to be inserted into the chamber. The housing is attached to the main body and covers the chamber. The latching member includes a first end portion and a second end portion. The first end portion is rotatably attached to the latching portion, and the second end portion is detachably attached to the locking portion.

### BACKGROUND

1. Technical Field

The present disclosure relates to a battery holder, particularly, to a battery holder used in a portable electronic device.

2. Description of Related Art

Portable electronic devices, such as mobile phones, include batteries installed therein to supply electric power. A conventional portable electronic device generally includes a main body and a battery cover. The main body defines a chamber for receiving the battery, and the cover is attached to the housing to lock the battery in the chamber. A number of hooks are formed on the battery and a number of latching holes is defined in the main body. The cover firmly attaches to the main body by engagement between the hooks and the latching holes.

However, it may be hard to detach the hooks from the latching holes, and the hooks may wear and tear after repeat use.

Therefore, there is room for improvement within the art.

### BRIEF DESCRIPTION OF THE DRAWINGS

Many aspects of the battery holder can be better understood with reference to the following drawings. The components in the drawings are not necessarily drawn to scale, the emphasis instead being placed upon clearly illustrating the principles of the battery holder.

FIG. 1 is an exploded, isometric view of a battery holder including a main body, a housing, and a latching member, in accordance with an exemplary embodiment.

FIG. 2 is an enlarged view of a circled portion II of the main body in FIG. 1.

FIG. 3 is an enlarged view of a circled portion III of the main body in FIG. 1.

FIG. 4 is an enlarged, isometric view of the latching member.

FIG. 5 is an assembled, isometric view of the battery holder shown in FIG. 1, showing the battery not received in the battery holder.

FIG. 6 is similar to FIG. 5, but showing the battery received in the battery holder.

FIG. 7 is similar to FIG. 6, but showing the latching member is locked.

### DETAILED DESCRIPTION

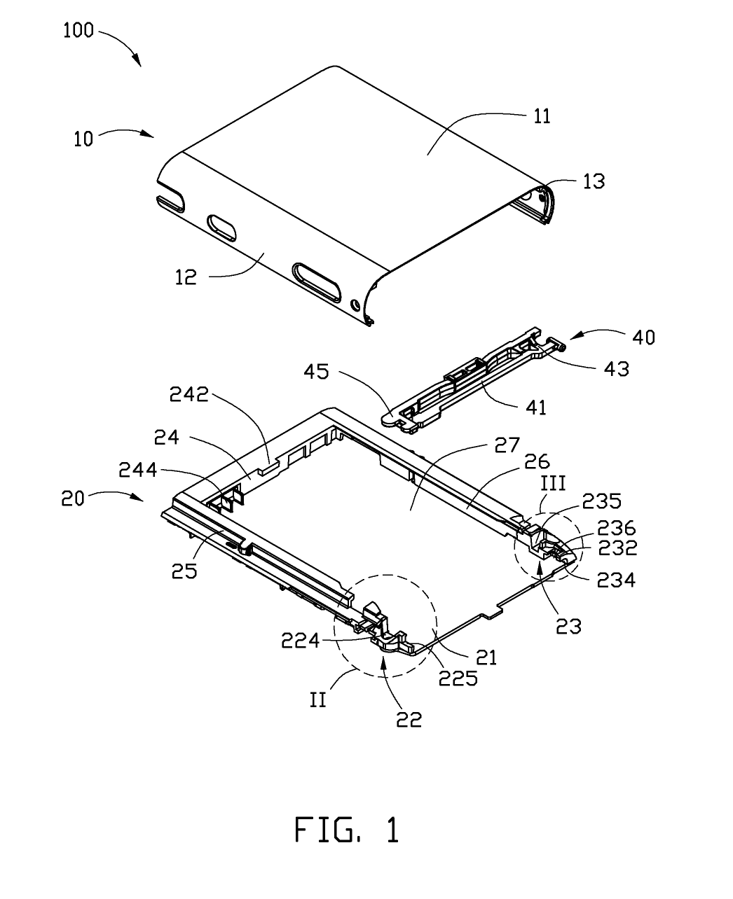

FIG. 1 shows an exemplary embodiment of a battery holder 100. The battery holder 100 is applied to a portable electronic device (not labeled), such as mobile phone, personal digital assistant (PDA) for example. The battery holder 100 includes a housing 10, a main body 20, and a latching member 40. The main body 20 may be one part of the portable electronic device

The housing 10 includes a main plate 11 and two side plates 12. A stepped engaging portion 13 is formed on each side plate 12 adjacent to the main plate 11 for engaging with the main body 20.

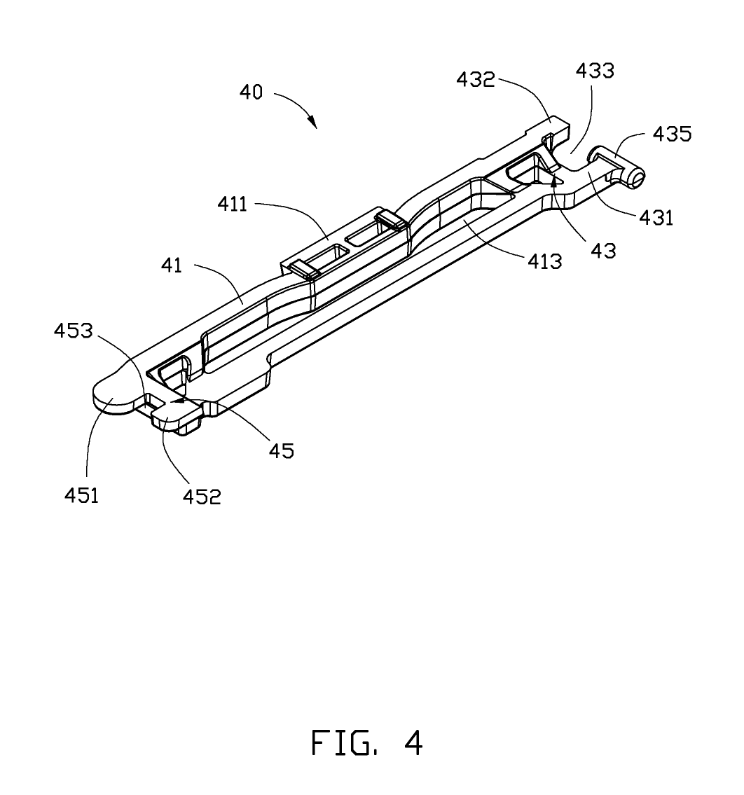

The main body 20 defines a chamber 27 for receiving a battery 200 (shown in FIG. 4). A first sidewall 25, an end wall 24, and a second sidewall 26 surround the battery chamber 27. The sidewalls 25 and 26 are engaged with the engaging portion 13 of the housing 10.

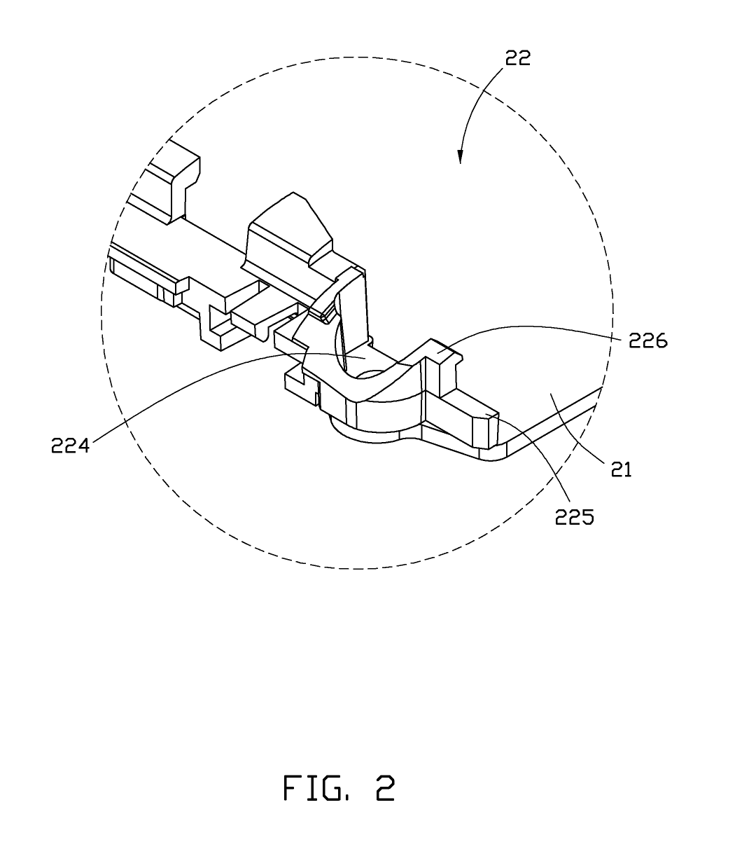

Also referring to FIG. 2, a locking portion 22 is formed at one end of the first sidewall 25. The locking portion 22 defines a receiving groove 224 and a cutout 225. A hook 226 is formed between the receiving groove 224 and the cutout 225.

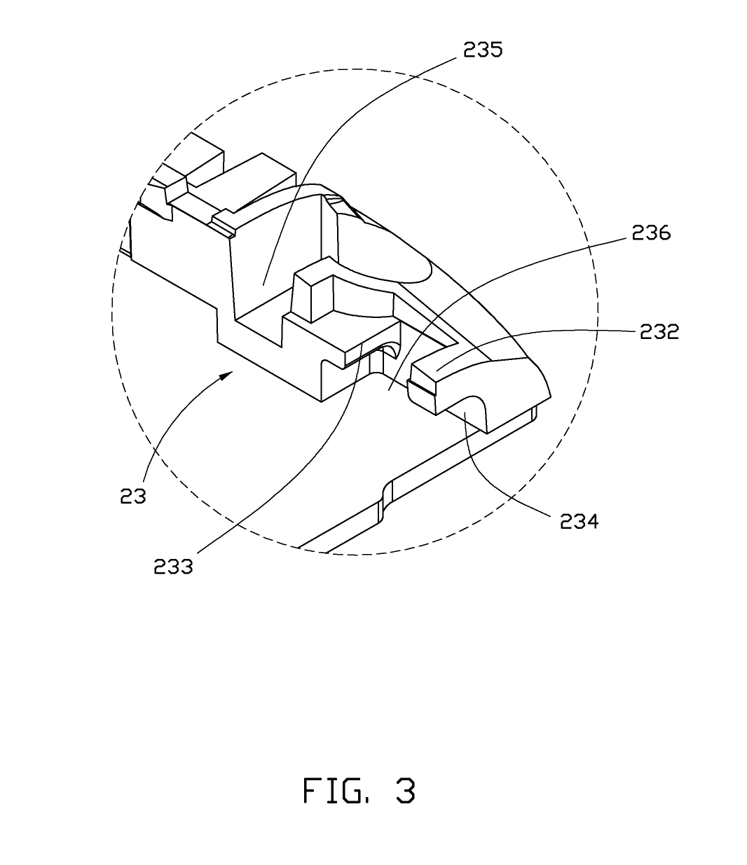

Also referring to FIG. 3, a latching portion 23 is positioned at one end of the second sidewall 26. The latching portion 23 defines a notch 234 and a slot 235. Two protrusions 232 and 233 extend over the notch 234. A space 236 is formed between the two protrusions 232 and 233. Referring to FIG. 1, an entrance 21 is formed between the locking portion 22 and the latching portion 23 communicating with the chamber 27. The entrance 21 allows the battery 200 to be inserted into the chamber 27.

A number of metal plates 244 is fixed on the end wall 24 for electrically connecting the battery 200 to a connector (not shown) in the portable electronic device. A projecting portion 242 is formed on the end wall 24 above the chamber 27 for locking the battery 200.

Referring to FIG. 4, the latching member 40 includes a main portion 41, a first end portion 43, and a second end portion 45. A block 411 extends from one side of the main portion 41. The main portion 41 may define a longitudinal through hole 413 to increase the elasticity of the main portion 41. In this exemplary embodiment, the latching member 40 is made of elastic material, such as rubber, to increase the elasticity of the main portion 41 and protect the battery 200 from damage.

The first end portion 43 includes a first bar 431, a second bar 432 and a gap 433 between the two bars 431 and 432. A shaft 435 is positioned at one end of the second bar 432, perpendicular to the second bar 432. The first bar 431 and the shaft 435 respectively engage in the slot 235 and the notch 234 of the latching portion 23.

The second end portion 45 includes a first tab 451, a second tab 452 and an retaining groove 453 between the two tabs 451 and 452. The first tab 451 and the second tab 452 respectively engage with the receiving groove 224 and the cutout 225 of the locking portion 22. The hook 226 extends through the retaining groove 453.

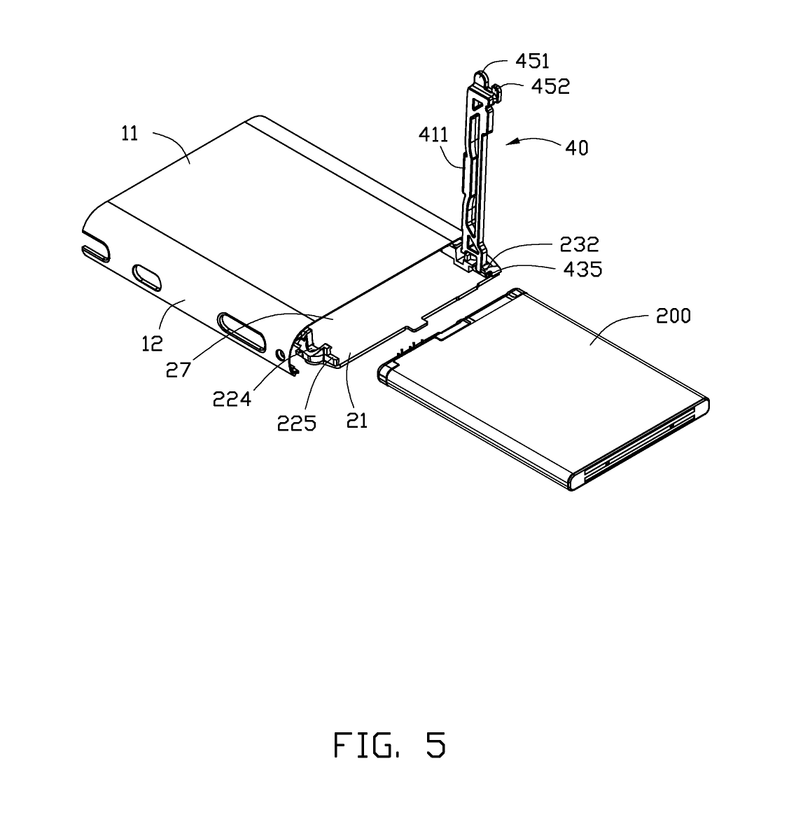

FIG. 5 shows the housing 10 and the latching member 40 attached to the main body 20. To attach the latching member 40 to the main body 20, the first bar 431 is engaged in the slot 235 of the latching portion 23. The second bar 432 is partially received in the space 236 between the two protrusions 232 and 233. The shaft 435 is rotatably received in the notch 234. Thus, the latching member 40 is rotatable relative to the shaft 435.

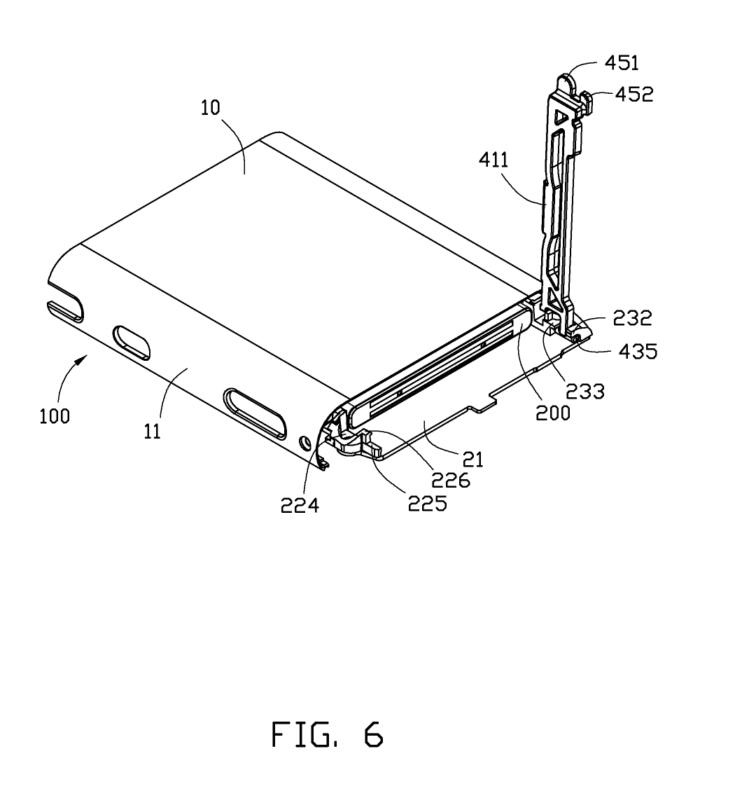

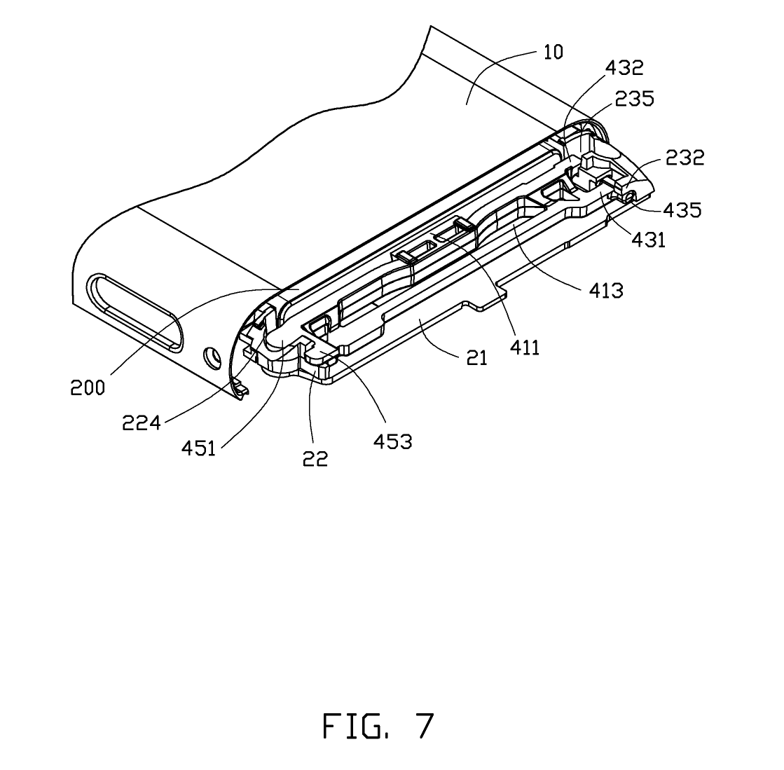

Also referring to FIGS. 6-7, while the latching member 40 is rotated up, the battery 200 is inserted into the chamber 27 through the entrance 21. The latching member 40 is then rotated down, and the second end portion 45 is pressed down. The hook 226 locks the second end portion 45, while the two tabs 451 and 452 are respectively engaged in the receiving groove 224 and the cutout 225. The block 411 abuts the battery 200 and pushes the battery 200 to firmly contact with the metal plates 244.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A battery holder comprising:
a main body defining a chamber, a locking portion and a latching portion respectively positioned on opposite sides of the chamber, a housing attached to the main body and covering the chamber; and
a latching member including a first end portion and a second end portion, the first end portion rotatably attached to the latching portion, and the second end portion detachably attached to the locking portion.

2. The battery holder of claim 1, wherein the locking portion comprises a hook to lock the second end portion.

3. The battery holder of claim 2, wherein the locking portion defines a receiving groove and a cutout, the second end portion includes a first tab engaged in the receiving groove and a second tab engaging in the cutout, and a retaining groove is formed between the first tab and the second tab allowing the hook extend through.

4. The battery holder of claim 1, wherein the latching portion defines a notch, and the first end portion includes a shaft received in the notch.

5. The battery holder of claim 4, wherein two protrusions extend over the notch to protect the shaft from separating from the notch.

6. The battery holder of claim 5, wherein the latching portion further defines a slot, a space is formed between the two protrusions, the first end portion comprises a first bar engaged in the slot and a second bar engaged in the space, and the shaft is perpendicular to the second shaft.

7. The battery holder of claim 1, wherein the latching member further comprises a main portion, and a block extends from one side of the main portion to abut the battery.

8. The battery holder of claim 7, wherein the main portion defines a longitudinal hole.

9. The battery holder of claim 8, wherein the latching portion is made of elastic material.

10. The battery holder of claim 9, wherein the latching portion is made of rubber.

11. The battery holder of claim 1, wherein the chamber is surrounded by a first sidewall, an end wall and a second sidewall, the locking portion is positioned at one end of the first sidewall, and the latching portion is position at one end of the second sidewall.

12. The battery holder of claim 11, wherein a projecting protrusion extends from the end wall for locking the battery.

13. The battery holder of claim 12, wherein the housing comprises a main plate and two side plates, an engaging portion is formed on each side plate adjacent to the main plate, and the engaging portions are engaged with the first and the second sidewalls correspondingly.

14. A battery holder for receiving a battery, the battery holder comprising:
a main body including a locking portion and a latching portion, an entrance defined between the locking portion and the latching portion, the entrance allowing the battery to be inserted into the main body; and
a latching member including a first end portion and a second end portion, the first end portion rotatably attached to the latching portion, and the second end portion detachably attached to the locking portion.

15. The battery holder of claim 14, wherein the locking portion comprises a hook to lock the second end portion.

16. The battery holder of claim 15, wherein the locking portion defines a receiving groove and a cutout, the second end portion includes a first tab engaged in the receiving groove and a second tab engaging in the cutout, and a retaining groove is formed between the first tab and the second tab allowing the hook to extend through.

17. The battery holder of claim 14, wherein the latching portion defines a notch, and the first end portion includes a shaft received in the notch.

18. The battery holder of claim 17, wherein two protrusions extend over the notch to protect the shaft from getting away from the notch.

19. The battery holder of claim 18, wherein the latching portion further defines a slot, a space is formed between the two protrusions, the first end portion comprises a first bar engaged in the slot and a second bar engaged in the space, and the shaft is perpendicular to the second shaft.

20. The battery holder of claim 14, wherein the latching member further comprises a main portion, the main portion defines a longitudinal hole, and a block extends from one side of the main portion to abut the battery.
